(19) United States
(12) Patent Application Publication
(10) Pub. No.: US 2010/0101876 A1
(43) Pub. Date: Apr. 29, 2010

(54) COMPOSITE GROUND CARGO VEHICLE

(75) Inventor: Stephen Misencik, Raleigh, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Martin Marietta Materials, Inc.

(21) Appl. No.: 12/257,702

(22) Filed: Oct. 24, 2008

(51) Int. Cl. B60K 6/00; B62D 33/00; B62D 25/20

(52) U.S. Cl. 180/65.21; 296/182.1; 296/184.1; 903/902

(57) ABSTRACT

A ground cargo vehicle has a chassis, multiple wheels mounted on the chassis such that the chassis is mobile upon the wheels, and a cargo compartment mounted on the chassis. The cargo compartment includes at least one panel constructed of a reinforced polymer composite material, and a lowered floor disposed lower than the top of at least one of the wheels. The vehicle may be powered by a hybrid drive system mounted on the chassis, the hybrid drive system including an internal combustion drive component and an electrical drive component. The floor may have a roadway height of less than 14 inches. The cargo compartment, cab compartment, chassis, and floor of the vehicle may be constructed entirely of lightweight reinforced polymer composite material.

### FIELD OF THE INVENTION

This invention relates generally to ground cargo vehicles, more particularly commercial ground cargo vehicles. The invention specifically relates to spacious and fuel-efficient ground cargo vehicles.

### BACKGROUND OF THE INVENTION

Vehicles generally constructed of metal such as steel and powered by diesel and gasoline drive systems make up most of the conventional ground cargo vehicle fleets in commercial delivery industries, such as ground delivery using Class 3 and Class 4 commercial vehicles. A steel construction has typically been used for such vehicles, but steel is typically heavy and drives up the costs of operating such a vehicle in terms of fuel efficiency and in terms of the adverse effect of the weight of the vehicle itself against net cargo weight capacity for any given gross vehicle weight rating.

Typical diesel and gasoline drive systems served the package delivery industries well in times when such fuels were abundant and cheap, and in times when concerns such as global warming were not recognized. However, escalating fuel costs and elevated environmental concerns are placing increasing demands on vehicle manufacturers and operators. In the package delivery industry, these demands are expressed in governmentally imposed regulations and in public perception toward cargo delivery companies that operate in shopping and residential districts.

It would be desirable to provide vehicles that are fuel efficient, are aesthetically acceptable, and that provide generous cargo carrying capabilities in terms of both cargo volume and weight.

### BRIEF SUMMARY OF THE INVENTION

The present invention addresses the above needs and enables other advantages by providing a ground cargo vehicle having a sleek overall design and improved performance in fuel efficiency and cargo capacity. This is achieved by a variety of combinations of reinforced polymer composite body members and drive systems, including hybrid drive systems. In the various embodiments, the inventive ground cargo vehicle is cost efficient in terms of using less fuel (e.g., diesel or other combustibles) in daily operation and in terms of reduced incidence of driver injury arising from repetitive movements (e.g., taking multiple steps up and down in transitioning between the ground level, the driver cab level, and the cargo level). The efficiency of the vehicle is further illustrated in that the embodiments of the vehicle allow for a reduced overall empty weight and increased overall cargo volume (in comparison to a conventional, steel frame, diesel engine ground cargo vehicle).

In one particular embodiment, a ground cargo vehicle according to the invention comprises an upper housing that is formed of a reinforced polymer composite material. The upper housing partially defines a cargo compartment of the ground delivery vehicle. The vehicle can further comprise a chassis with multiple wheels mounted thereon such that the chassis is mobile upon the wheels. In one embodiment, the chassis can also be formed of a reinforced polymer composite material. The chassis can be combined with the upper housing to define the cargo compartment of the ground delivery vehicle. The vehicle also comprises a floor, which can, in specific embodiments, be an upward-facing surface of the chassis. The floor preferably partially defines the cargo compartment and also partially defines a cab compartment (which can be further defined by the upper housing of the ground delivery vehicle). In specific embodiments, the chassis and the floor can comprise a single component (e.g., the floor can be a substantially flat, upward facing surface of the chassis). The vehicle can also comprise a bulkhead that separates the cab compartment from the cargo compartment. In preferred embodiments, the floor of the ground delivery vehicle is uniform in height from the cargo compartment to the cab compartment and defines the lowest portion of the cargo compartment and the cab compartment. In specific embodiments, the floor is disposed lower than the top of at least one of the wheels. The ground cargo vehicle preferably comprises a rear door which, together with the upper housing, the floor, and the bulkhead can define the complete interior space that forms the cargo compartment.

The ground cargo vehicle also includes a drive system mounted on the chassis, and the drive system can vary depending upon the desired form of the vehicle. For example, in one embodiment, the drive system can be a conventional internal combustion engine, such as a diesel engine. Preferably, the internal combustion engine is a 4-cylinder diesel internal combustion engine. In further embodiments, the drive system can comprise a hybrid drive system. In a specific embodiment, the hybrid drive system includes an internal combustion drive component and an electrical drive component.

In at least one embodiment of the invention, a ground cargo vehicle according to the invention comprises the following components: a chassis formed of a reinforced polymer composite material and having an upward-facing surface defining a floor; a drive system mounted on the chassis; an upper housing attached to the chassis and formed of a reinforced polymer composite material; a driver bulkhead; a rear door (the floor, the upper housing, the driver bulkhead, and the rear door together defining a cargo compartment with an interior space having a defined cargo volume); and a cab compartment positioned forward to the cargo compartment and separated therefrom by the driver bulkhead. Preferably, the floor of the ground cargo vehicle defines the lowest portion of the cargo compartment and the cab compartment and is uniform in height from the cargo compartment to the cab compartment. The ground cargo vehicle of the invention has an overall weight that is at least about 20% less than the overall empty weight of a delivery vehicle of the same class rating but formed of conventional materials (e.g., metal chassis and metal body). For example, in one embodiment, the ground cargo vehicle has an overall empty weight of less than or equal to about 8,000 pounds. In further embodiments, the interior space of the cargo compartment has a volume of at least about 1,000 cubic feet. In one specific embodiment, the chassis, the upper housing, and the driver bulkhead are an integrated, self-supporting monocoque construction molded as one piece and comprised completely of a reinforced polymer composite material.

In another aspect, the invention provides a method for reducing the cost of operation of a ground cargo delivery vehicle. Preferably, the method comprises forming a ground cargo delivery vehicle as described herein and using the ground cargo delivery vehicle in a daily operation for ground cargo delivery. In a preferred embodiment, the step of forming the ground cargo delivery comprises forming the vehicle to have a chassis formed of a reinforced polymer composite material and having an upward-facing surface defining a floor of the vehicle, a hybrid drive system mounted on the chassis, an upper housing attached to the chassis and formed of a reinforced polymer composite material, a driver bulkhead, and a rear door (the floor, the upper housing, the driver bulkhead, and the rear door together defining a cargo compartment with an interior space having a defined cargo volume). Preferentially, the vehicle is formed to have an overall empty weight that is at least about 20% less than the overall empty weight of a delivery vehicle of the same class rating but formed of conventional materials (e.g., metal chassis and metal body) and a cargo compartment volume of at least about 1,000 cubic feet.

### BRIEF DESCRIPTION OF THE DRAWINGS

Having thus described the invention in general terms, reference will now be made to the accompanying drawings, which are not necessarily drawn to scale, and wherein:

FIG. 1 is a side elevation view of a ground cargo vehicle in accordance with at least one embodiment of the invention;

FIG. 2 is a front elevation view of the ground cargo vehicle of FIG. 1;

FIG. 3 is a rear-elevation view of the ground cargo vehicle of FIG. 1;

FIG. 4 is a rear perspective view of the ground cargo vehicle of FIG. 1;

FIG. 5 is a front perspective view of the ground cargo vehicle of FIG. 1;

FIG. 6 is an exploded perspective view of the ground cargo vehicle of FIG. 1 taken from the perspective FIG. 5;

FIG. 7 is a diagrammatic representation of the hybrid drive system of the ground cargo vehicle of FIG. 1; and

FIG. 8 is a bottom perspective view illustrating a monocoque construction of multiple components of a ground cargo vehicle according to at least one embodiment of the invention.

### DETAILED DESCRIPTION OF THE INVENTION

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise.

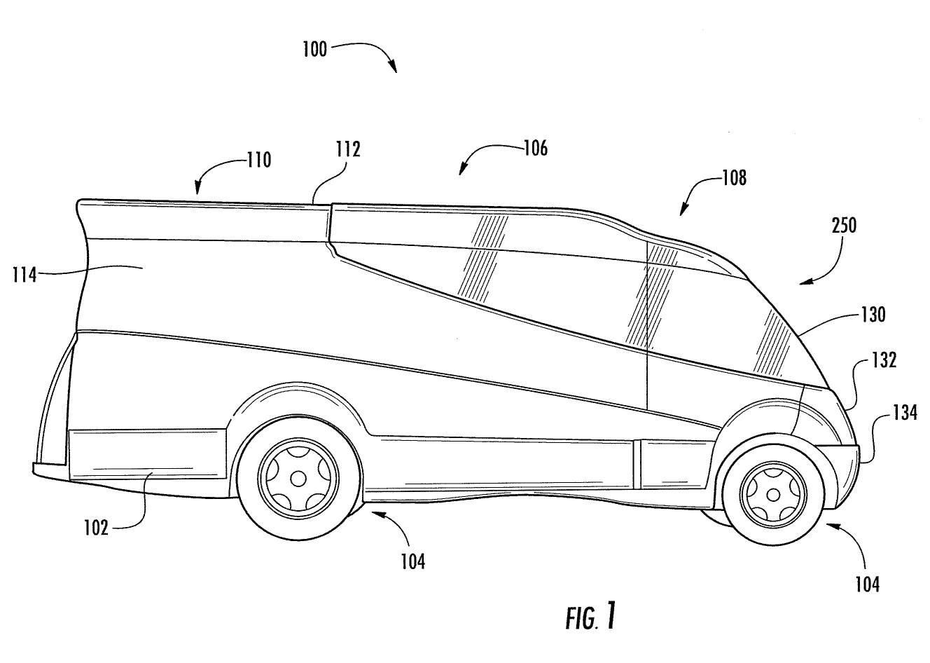

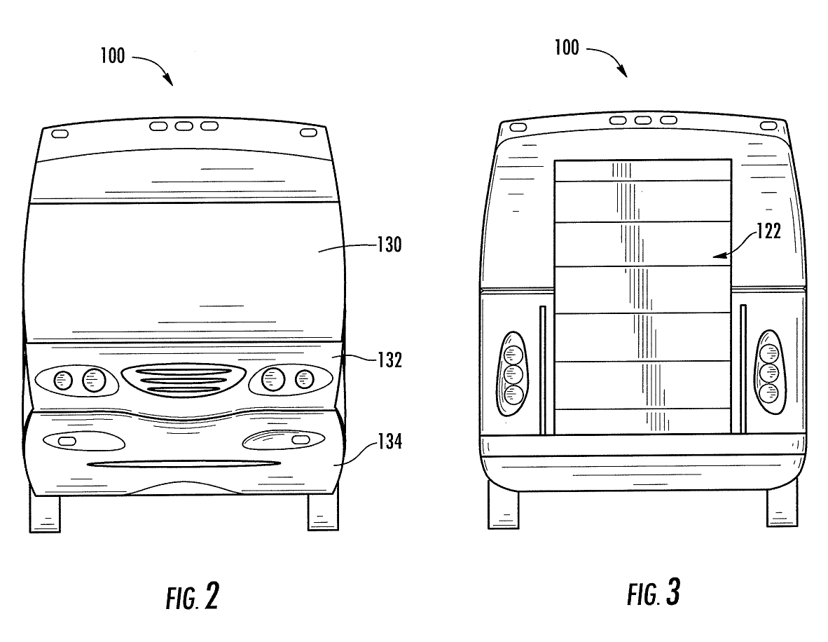

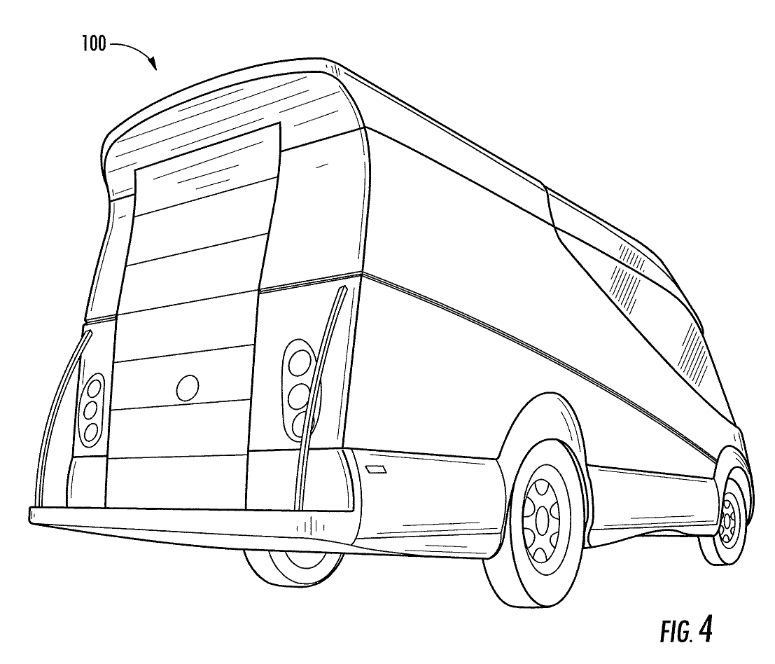

A ground cargo vehicle 100 according to at least one embodiment of the invention is depicted in FIG. 1. The vehicle includes a chassis 102 and multiple wheels 104 upon which the vehicle is mobile. The body of the vehicle 100 generally comprises a forward cab compartment 108 and a rearward cargo compartment 110. The forward cab compartment 108 includes a windshield 130, a hood/engine cover 132, and a bumper 134. The cargo compartment 110 includes a roof 112 and sidewalls 114. Front and rear views (FIG. 2 and FIG. 3, respectively) further illustrate the general construction of the cargo vehicle 100. In FIG. 3, the cargo vehicle is particularly seen to include a rear door 122.

The body of the ground cargo vehicle 100 can be formed of a number of individual panels that are combined to make the overall vehicle body. Preferably, one or more of such panels is constructed of light-weight reinforced polymer composite material, as more fully described below. For example, as shown in FIG. 1, the roof 112 and the sidewalls 114 can be defined by respective panels, which may have both planar and arcuate portions. Similarly, the cab compartment 108 may be formed of a number of individual panels, one or more of which may comprise a reinforced polymer composite material. Such panels can be sectionally molded and the individual parts bonded together to form the upper housing of the vehicle.

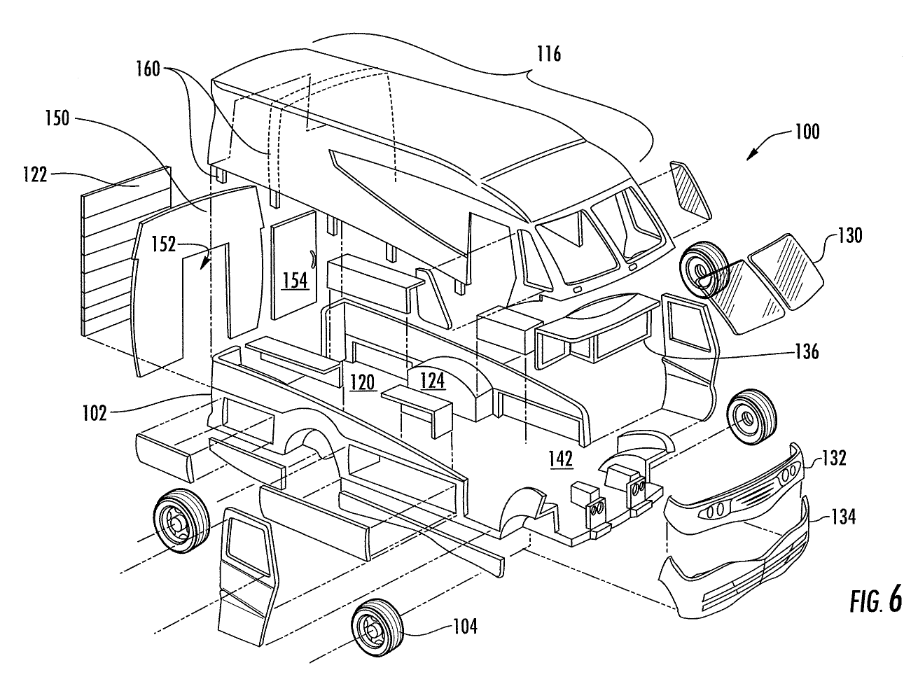

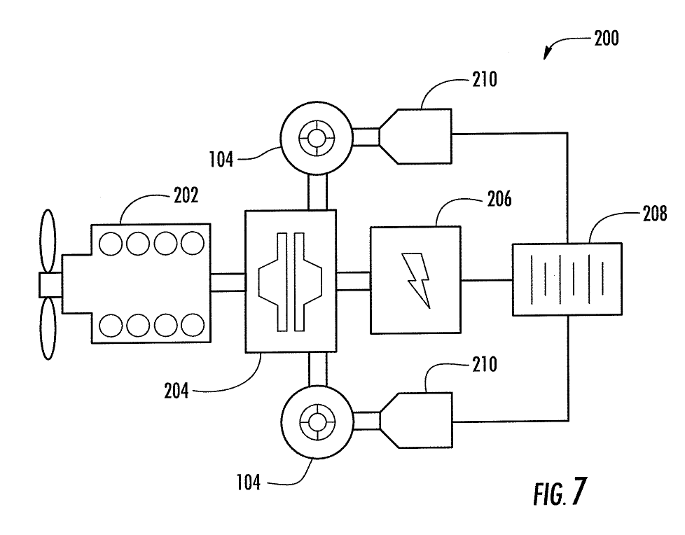

In certain embodiments, as shown in FIG. 5, the body of the ground cargo vehicle can be described as an upper housing 116, which can specifically be formed of the forward cab compartment 108 and the rearward cargo compartment 110. In particular, the upper housing 116 can be a single structure that forms the cargo compartment 110 or both the cargo compartment 110 and the cab compartment 108. Thus, the upper housing can also include the roof 112 and the sidewalls 114. The upper housing 116, can also include the framework for holding the windshield 130 and any side windows included in the vehicle. Such a single construction is particularly illustrated by the upper housing 116 shown in FIG. 6. Alternately, as noted above, the upper housing 116 can be a combination of parts that are separately molded and then bonded together.

As further illustrated in FIG. 6, the upper housing 116 is preferably attached to the chassis 102. Such attachment can be by any means. In FIG. 6, the upper housing 116 includes one or more internal ribs 160 that assist in stabilizing the upper housing 116 and also attaching the upper housing 116 to the chassis 102.

As also illustrated in FIG. 6, the ground cargo vehicle further includes a number of additional components that are generally interior to the vehicle. For example, the ground cargo vehicle includes floor 120, a driver bulkhead 150, and a rear door 122. Together, the upper housing, the floor, the bulkhead, and the rear door define the cargo compartment of the ground cargo vehicle. Particularly, the cargo compartment is formed of an interior space that provides a defined cargo volume.

The floor of the ground cargo vehicle can be separate from the chassis (i.e., can be a component attached to the chassis). In specific embodiments, such as illustrated in FIG. 6, the floor 120 is integral to the chassis 102. In other words, the chassis itself comprises an upward-facing surface that forms the floor of the ground cargo vehicle. The floor preferably defines the lowest portion of the cargo compartment. Advantageously, the floor is disposed lower than the tops of the rearward wheels. This arrangement permits easy access to the cargo compartment through the rear door 122, optionally without the use of a ramp. This arrangement further permits increased internal volume of the cargo compartment when compared to a conventional ground cargo vehicle having a floor that is disposed entirely above the rear wheels. That is, for a given width, length, and height in relation to the roadway, the lowered floor permits increased internal volume of the cargo compartment. Increased internal volume provides for increased carrying capacity of cargo packages, particularly in a loading scenario wherein the cargo compartment is spatially filled with light-weight packages without meeting the total carrying weight capacity of the vehicle.

In at least one embodiment, the lowered floor 120 has a height of less than about 24 inches, preferably less than about 14 inches. The height of the floor is defined as the relation of the floor to the surface (e.g., a roadway) upon which the vehicle itself is disposed. This may be a fixed or kneeling height of the floor. That is, the lowered floor 120 may be disposed at a relatively fixed height, with some variations due to the variable weight of fuel and cargo loads that variably compress the suspension components of the vehicle, which may include both spring and pneumatic suspension components. The lowered floor may also be disposed at a variable height according to the disposition of a powered variable-height suspension system that raises and kneels according to a selector control system available to the driver in the cab compartment.

The cargo compartment includes wheel wells 124 extending up from the floor in the interior of the cargo compartment. The wheel wells 124 receive and accommodate the rearward wheels along the exterior of the compartment to isolate the interior of the compartment and any packages therein from the revolving wheels as the vehicle travels. As seen in FIG. 6, the floor 120 of the cargo vehicle is disposed lower than the top of the wheel wells 124, which illustrates how the floor 120 is disposed lower than the top of the wheel 104, which are accommodated by the wheel wells 124.

In specific embodiments, the drive system used by the vehicle can comprise one or more components extending adjacent the floor of the vehicle. In such embodiments, the chassis of the ground cargo vehicle (which may include the floor of the vehicle) may include one or more channels to accommodate the drive system components. This is particularly possible when the chassis is formed of a reinforced polymer composite material.

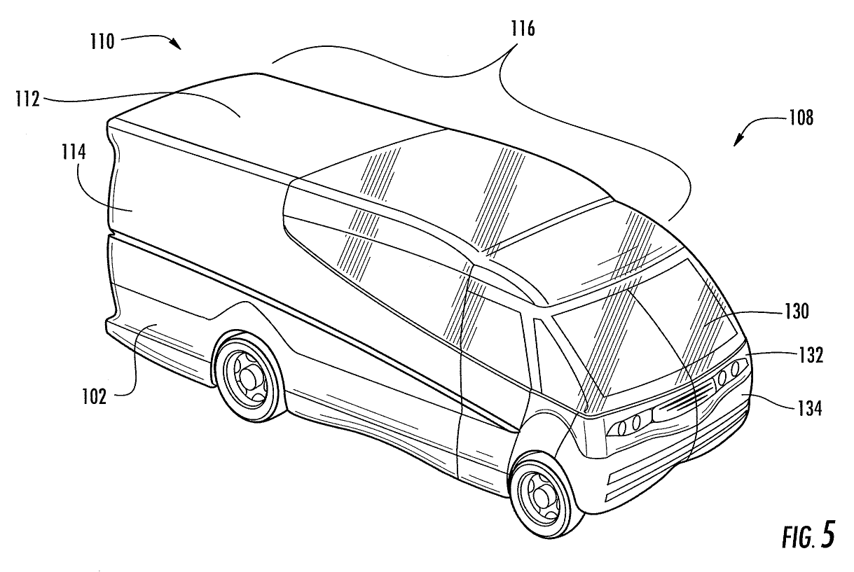

The rear door 122 can be raised and stowed along the roof of the upper housing to permit access to the interior of the cargo compartment. The rear door is constructed of hinged panels to permit the door to pass about a radius of curvature in passing from the lowered and closed disposition as shown in FIGS. 3 and 4 to a raised and opened disposition (not shown) wherein the door is stowed along the roof of the upper housing and within the interior of the cargo compartment.

The cab compartment 108 of the ground cargo vehicle also includes a floor. Preferably, as illustrated in FIG. 6, the cab compartment floor 142 is disposed at approximately the same height at the floor 120 of the cargo compartment. In specific embodiments, the floor of the ground cargo vehicle is at a uniform height from the cargo compartment to the cab compartment. Thus, the floor may be described as a “walk-through” floor. In other words, an individual is able to walk from the cab compartment to the cargo compartment (and vice-versa) without encountering an intervening step. In conventional delivery vehicles, the cab compartment floor and the cargo compartment floor are disposed at different heights. Thus, to move between the two compartments, the vehicle driver must step up or step down. This is an undesirable situation, as the added stepping and the height differences present multiple opportunities every day for the vehicle driver to misstep and be injured.

In specific embodiments, a driver bulkhead 150, having a doorway 152, delineates the interior of the cargo compartment from the interior of the cab compartment and protects the driver in the event of forward shifting of cargo packages. Optionally, a door 154 is attached by hinges or other adjustable mechanical means to the driver bulkhead to permit opening and closing of the doorway. Advantageously, the floors of the cargo compartment and the cab compartment, having similar heights, and the doorway define a walkthrough arrangement such that a driver of the vehicle can pass conveniently between the cab compartment and the cargo compartment through the doorway 152 without climbing stairs or the like. In preferred embodiments, the floor defines the lowest portion of the cargo compartment and the cab compartment.

As seen in FIG. 6, the upper housing 116, the driver bulkhead 150, the floor 142, and the dashboard 136 together form the cab compartment 108. External to the dashboard 136 is the engine component (not shown), which is itself covered by the hood/engine cover 132.

As described above, the inventive ground cargo vehicle is a combination of component parts. In one embodiment, the vehicle can be defined as comprising an engine cradle, a shell (or body), a front end (positioned under the windshield), a rear end (which includes the rear door), and a chassis.

In addition to the body components, the ground cargo vehicle comprises a drive system attached to the chassis. A variety of different drive systems can be used according to the invention. In one embodiment, the vehicle includes a conventional internal combustion engine. Unlike conventional delivery vehicles, the ground cargo vehicle of the present invention can advantageously use an engine with a smaller displacement that provides improved fuel efficiency. As further described below, conventional delivery vehicles are formed of heavy materials, such as steel, and the overall weight of the conventionally structured vehicle is such that an engine of sufficient power is needed to propel the truck, particularly when fully loaded with cargo. The ground cargo vehicle of the present invention, however, overcomes this problem.

In one embodiment, the ground cargo vehicle of the invention comprises a body formed of reinforced polymer composite materials. For example one or more panels forming the upper housing can be made using reinforced polymer composite materials. Preferably, the entire upper housing is made of reinforced polymer composite materials. Such reinforced polymer composite body structure greatly reduces the overall empty weight of the inventive ground delivery vehicle. Since the weight is reduced, it is possible to make use of a conventional internal combustion engine that provides less power output but provides increased fuel efficiency. In one embodiment, the drive system of the inventive ground cargo vehicle comprises a 4-cylinder diesel internal combustion engine. Non-limiting examples of 4-cylinder diesel engines that can be used according to the present invention include those available from Mercedes-Benz (e.g., 4.3L Mercedes OM904 I4 diesel), Isuzu, and Toyota. For example, technical paper number 820116 from SAE International entitled “The New Isuzu 1.8 Liter 4-Cylinder Diesel Engine for the United States Market” describes one 4-cylinder diesel engine that could be used according to the invention.

In another embodiment, it is useful for both the chassis and the upper housing of the inventive ground cargo vehicle to comprise reinforced polymer composite materials. This even further reduces the overall empty weight of the vehicle. Thus, according to this embodiment, it is still possible to use conventional internal combustion drive systems. Preferably, the internal combustion drive system is a reduced power engine that provides increased fuel economy, such as a 4-cylinder diesel internal combustion engine.

In specific embodiments, the ground cargo vehicle of the invention is powered by a hybrid drive system. Any hybrid drive system useful in “truck-type” vehicles can be used according to the invention. The term “truck-type” refers to vehicles in the category of light or medium trucks. Non-limiting examples of hybrid drive systems useful according to the invention include those available from Eaton Corporation and Azure Dynamics Corporation. Examples of hybrid electric drive systems are disclosed in U.S. Pat. No. 6,651,759; U.S. Pat. No. 6,612,246; U.S. Pat. No. 6,484,830; U.S. Pat. No. 6,242,873; U.S. Pat. No. 6,209,672; U.S. Pat. No. 6,018,198; and U.S. Pat. No. 5,945,808, all of which are incorporated herein by reference.

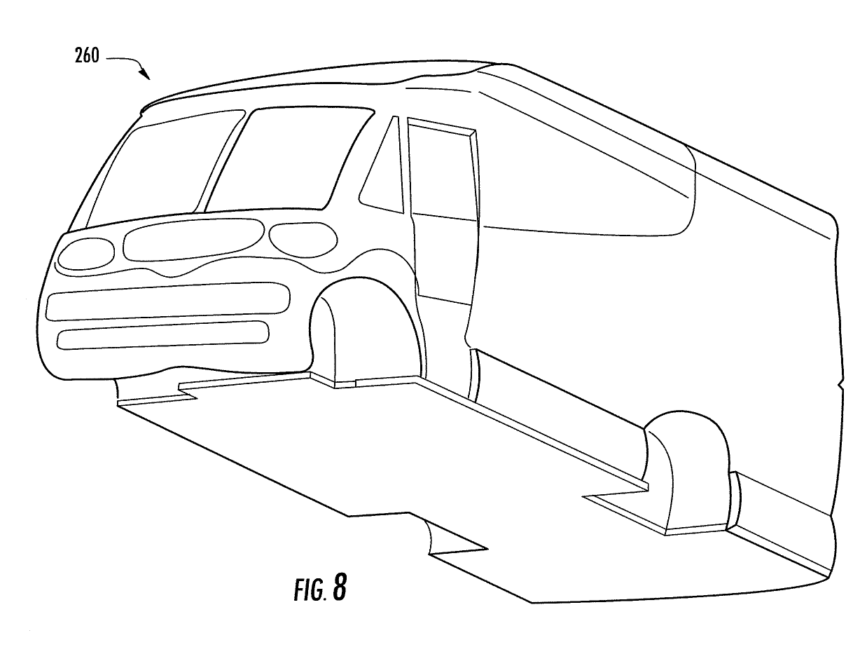

One embodiment of a hybrid drive system 200 is diagrammatically represented in FIG. 7. In this embodiment, an internal combustion engine 202 generates mechanical power that is communicated through a clutch system 204 both to drive wheels 104 and to an electrical generator 206. Thus the hybrid drive system is capable of motivating the vehicle for movement by mechanical linkage, which may include a multi-speed transmission system (not shown) between the internal combustion engine 202 and the drive wheels 104. The hybrid drive system is further capable of motivating the vehicle for movement by electromechanical means. That is, the electrical generator 206, turned by the internal combustion engine 200 through the clutch system 204, and optionally other mechanical linkage elements, produces electrical power and is disposed in electrical communication with an electrical storage device 208 such as a battery or capacitor system. The electrical storage device 208 is disposed in electrical communication with one or more electrical motors 210 that are mechanically linked to the drive wheels 104, which may represent both forward and rearward wheels of the vehicle such that the vehicle may be a rear-wheel drive vehicle, a front-wheel drive vehicle, or an all-wheel drive vehicle.

In at least one embodiment of the hybrid drive system, a controller linked to an accelerator pedal in the cab compartment accelerates the vehicle through the electrical motors 210, which are powered by the electrical storage device 208. In that embodiment, the controller starts and stops the internal combustion engine 202 automatically, without direct control by the driver of the vehicle, to maintain electrical power storage in the electrical storage device.

In at least one embodiment of the ground cargo vehicle 100, the hybrid drive system 100 defines a series/parallel hybrid drive system providing advantages over both of series hybrid systems and parallel hybrid systems. In a series hybrid system, the internal combustion engine is decoupled from the drive line in that the engine provides torque to a generator but not directly to a transmission or drive wheels. Thus, in a series hybrid system, the electrical generator, the electrical storage device, and the electrical motors linked to the drive wheels must have sufficient power delivery capabilities to meet vehicle performance needs at the greatest gross weight of a loaded vehicle. In relation to a parallel hybrid system, the relatively more powerful generator, storage device, and electrical motors of a series hybrid system, which meet high continuous power requirements, provide cost effective operations in driving situations where trips are characterized by many stops and starts, such as in city driving.

In a parallel hybrid system, the internal combustion engine is coupled to the drive line through a clutch system, which provides torque both to the drive wheels and an electrical generator. The electrical generator, electrical storage device, and electrical motors are thereby subjected to lower peak power demands than in a series hybrid system. In a parallel hybrid system, the internal combustion engine provides for the bulk of the continuous power requirements while the electrical motors assist with transient peak power requirements. In relation to a series hybrid system, a parallel hybrid system provides poor efficiency performance in city driving but prevails in high load highway driving.

In the series/parallel hybrid system embodiment of the present invention, a smaller generator is required in relation to the parallel hybrid system to obtain benefits similar to those of a series hybrid system at lighter vehicle loads. A control strategy is utilized to optimally select the mode of operation, whether series or parallel, based on vehicle power requirements, state of charge in the electrical storage device, and engine efficiency. Thus, the series/parallel hybrid system embodiment of the present invention provides high fuel efficiency in a variety of driving situations, including both city and highway driving.

The ground cargo vehicle is also beneficial in that certain functional and structural components can be used or eliminated. For example, in one embodiment of the invention, the vehicle includes a trailing-arm suspension rather than a conventional axle suspension. Thus, the inventive vehicle can be further described as expressly excluding a rear axle component.

The outward shape of the vehicle 100 provides a sloped forward face 250 (FIG. 1) and smooth aerodynamic contours along the sides of the vehicle to minimize wind resistance and to thereby promote fuel efficiency. The styling of the vehicle is believed to be appealing and modern and will likely instill perceptions of efficiency and innovation in the public upon viewing the vehicle. These perceptions will likely be attributed to the operator of the vehicle and will therefore likely promote the business endeavors of the operator.

A wide variety of reinforced polymer composite materials can be used in preparing part, or all, of the cargo and cab compartments of the inventive vehicle. Fiber reinforced polymer structures typically comprise a polymeric resin having a reinforcing fiber element embedded therein. Exemplary fiber reinforced panel structures include, but are not limited to, a solid laminate, a pultruded or vacuum-infused sandwich panel (e.g., a panel having upper and lower skins with a core therebetween), or a pultruded panel (e.g., a panel having upper and lower skins with vertical or diagonal webs therebetween). Exemplary core materials include wood, foam, and various types of honeycomb. Exemplary polymer resin materials include thermosetting resins, such as unsaturated polyesters, vinyl esters, polyurethanes, epoxies, phenolics, and mixtures thereof.

The fiber reinforcing element may comprise E-glass fibers, although other reinforcing elements such as S-glass, carbon fibers, KEVLAR®, metal (e.g., metal nano-fibers), high modulus organic fibers (e.g., aromatic polyamides, polybenzamidazoles, and aromatic polyimides), and other organic fibers (e.g., polyethylene and nylon) may be used. Blends and hybrids of such materials may also be used as a reinforcing element. Other suitable materials that may be used as the reinforcing element include whiskers and fibers constructed of boron, aluminum silicate, or basalt. Exemplary fiber reinforced panels and methods of making such panels are disclosed in the following U.S. patents: U.S. Pat. Nos. 5,794,402; 6,023,806; 6,044,607; 6,108,998; 6,645,333; and 6,676,785, all of which are incorporated herein in their entirety.

Specific components of the inventive vehicle, such as sidewall sections, the bulkhead panel, and the cargo floor, can be constructed as a sandwich panel having a core and two laminated skins secured to opposite sides of the core. An exemplary commercial embodiment of a suitable sandwich panel is the TRANSONITE® composite panels available from Martin Marietta Composites of Raleigh, N.C. In one embodiment, the core of the sandwich panel is formed of a foam material with a plurality of fibers extending through the foam and connecting the two laminated skins secured to each opposing surface of the foam core.

In at least one embodiment of the vehicle 100, the shell (or body) of the vehicle is constructed entirely of lightweight reinforced polymer composite materials and thus provides considerable advantages with regard to empty-vehicle weight, net cargo-weight capacity, and fuel efficiency in relation to conventional ground cargo vehicles. In preferred embodiments, one or more of the upper housing (i.e., the roof and the side panels), the chassis, the driver bulkhead, the hood/engine cover, the dashboard, and the bumper is formed of a reinforced polymer composite material.

In a particular embodiment, the upper housing and the chassis are fabricated together in an integrated self-supporting monocoque construction molded as one piece 260 as shown in FIG. 8. Such monocoque construction can further include one or more of the driver bulkhead, the hood/engine cover, the dashboard, and the bumper. It is believed that such a construction provides a light-weight, durable, fuel efficient and low-maintenance ground cargo vehicle that meets proposed emission regulations and is minimally adverse to populations and civil infrastructures such as neighborhood developments.

Particular estimates shown in Table 1 demonstrate that a reinforced polymer composite hybrid vehicle according to at least one embodiment of the invention can provide a lowered empty-vehicle weight, a raised net cargo-weight capacity, and a notable fuel savings when compared to both conventional diesel and conventional hybrid vehicles. In Table 1, estimates are provided for the following vehicles: (1) a “Conventional Diesel” vehicle having a typical (non-hybrid) drive system (e.g., at least a 6-cylinder internal combustion engine) and typical metal cargo and cab compartments; (2) a “Conventional Hybrid” vehicle having a hybrid drive system and a typical metal cargo compartment and a typical metal cab compartment; and (3) a “Reinforced Polymer Composite Hybrid” vehicle according to the invention comprising a composite body structure and a hybrid drive system. In order to provide meaningful comparisons, the three vehicles compared in Table 1 were selected to have a common gross vehicle weight rating, which represents the maximum total weight a loaded vehicle is rated to reach for continuous safe operation. Of course, the net cargo-weight capacity of any vehicle in Table 1 is the difference between the gross vehicle weight rating and the empty-vehicle weight.

TABLE 1

| | Conventional | Conventional | Reinforced Polymer |
|---|---|---|---|
| | Diesel | Hybrid | Composite Hybrid |
| Gross Vehicle Weight | 21,000 | 21,000 | 21,000 |
| Rating (lbs.) | | | |
| Cargo Compartment | 1,000 | 800 | 1,000 |
| Volume (cubic feet) | | | |
| Empty-Vehicle | 12,000 | 14,000 | 8,000 |
| Weight (lbs.) | | | |
| Net Cargo-Weight | 9,000 | 7,000 | 13,000 |
| Capacity (lbs.) | | | |
| Fuel Savings | Baseline | ~30% | ~40-50% |
| | (0%) | | |

It is notable that hybrid drive systems tend to be heavier than convention internal combustion engine drive systems when the weight of electrical storage devices, which are typically heavy battery banks, are included in the weighing of the drive systems. Thus, the conventional hybrid vehicle in Table 1 demonstrates a higher empty-vehicle weight and a lower net cargo-weight capacity than the conventional diesel vehicle having the same gross vehicle weight rating. Nonetheless, even the conventional hybrid vehicle in Table 1 demonstrates savings in fuel efficiency over the conventional diesel vehicle. However, the reinforced polymer composite hybrid vehicle of Table 1 demonstrates both a higher net cargo-weight and fuel savings over both of the other vehicles in Table 1.

In the embodiment of the reinforced polymer composite hybrid vehicle for which estimates are provided in Table 1, the combination of a reinforced polymer composite body structure with a hybrid drive system allows for the lowered floor and provides increased fuel savings and increased net cargo weight capacity, without loss in cargo volume capacity. The hybrid drive system allows for the lowered floor by reducing conventional drive components under the chassis. Thus, the hybrid drive system and lowered floor permit embodiments of the ground cargo vehicle of the present invention to have a cargo compartment volume comparable or higher than conventional diesel vehicles and conventional hybrid vehicles in the same gross vehicle weight rating class. This will conserve fuel, minimize mileage, and save driving time by reducing the number of necessary trips in scenarios where lighter packages fill the vehicle.

The reinforced polymer composite construction of the composite hybrid vehicle for which estimates are provided in Table 1 provides a lowered empty vehicle weight relative to delivery vehicles of the same class rating but formed of conventional materials (e.g., metal chassis and metal body). Empty weight, as used herein, means a completed, functional vehicle (i.e., including drive components) with no cargo loaded therein. Ground delivery vehicles of particular classes (e.g., Class 3 and Class 4 commercial vehicles) are understood in the art and known empty weights in a given range. Thus, a skilled person would recognize the overall empty weight of such class vehicles. For example, Class 4 and Class 4 commercial vehicles formed of a metal chassis and metal body typically have an overall empty weight in the range of about 12,000 to 13,000 pounds.

Preferably, the ground cargo vehicle of the invention has an overall weight that is at least about 10% less than the overall empty weight of a delivery vehicle of the same class rating but formed of conventional materials (e.g., metal chassis and metal body). In further embodiments, the inventive ground cargo vehicle has an overall weight that is at least about 15%, at least about 20%, at least about 25%, or at least about 30% less than the overall empty weight of a delivery vehicle of the same class rating but formed of conventional materials.

In certain embodiments, the ground cargo vehicle of the invention has an overall empty weight that is less than or equal to about 11,000 pounds. In further embodiments, the inventive cargo vehicle has an overall empty weight that is less than or equal to about 10,500 pounds, less than or equal to about 10,000 pounds, less than or equal to about 9,500 pounds, less than or equal to about 9,000 pounds, less than or equal to about 8,500 pounds, or less than or equal to about 8,000 pounds.

The reduced weight of the inventive cargo vehicle provides a raised net cargo weight capacity is beneficial for minimizing mileage and saving driving time by reducing the number of necessary trips in scenarios where heavier package loads meet the net cargo weight capacity. This will also dedicate more fuel consumption to payload carriage as opposed to vehicle movement costs when the vehicle is loaded and will reduce fuel consumption for unloaded vehicles returning from deliveries or traveling to a load pick-up location.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A ground cargo vehicle comprising:
a chassis;
multiple wheels mounted on the chassis such that the chassis is mobile upon the wheels;
a drive system mounted on the chassis and comprising a plurality of drive components;
an upper housing attached to the chassis and comprising a reinforced polymer composite material;
a floor;
a driver bulkhead; and
a rear door;
wherein the floor, the upper housing, the driver bulkhead, and the rear door together define a cargo compartment with an interior space having a defined cargo volume.

2. The ground cargo vehicle according to claim 1, wherein the chassis is formed of a reinforced polymer composite material.

3. The ground cargo vehicle according to claim 2, wherein the chassis comprises an upward-facing surface, and wherein the floor of the ground cargo vehicle comprises the upward-facing surface of the chassis.

4. The ground cargo vehicle according to claim 2, wherein the chassis comprises one or more channels for accommodating one or more of the plurality of drive components.

5. The ground cargo vehicle according to claim 1, wherein the drive system comprises a 4-cylinder diesel internal combustion engine.

6. The ground cargo vehicle according to claim 1, wherein the drive system comprises a hybrid drive system.

7. The ground cargo vehicle according to claim 6, wherein the hybrid drive system comprises an internal combustion drive component and an electrical drive component.

8. The ground cargo vehicle according to claim 1, wherein the floor is disposed lower than the top of at least one of the wheels.

9. The ground cargo vehicle according to claim 1, wherein the floor has a height of less than 24 inches.

10. The ground cargo vehicle according to claim 1, wherein the floor has a height of less than 14 inches.

11. The ground cargo vehicle according to claim 1, comprising a cab compartment positioned forward to the cargo compartment and separated therefrom by the driver bulkhead, wherein the floor of the ground cargo vehicle defines the lowest portion of the cargo compartment and the cab compartment and is uniform in height from the cargo compartment to the cab compartment.

12. The ground cargo vehicle according to claim 1, wherein the ground cargo vehicle has an overall empty that is at least about 20% less than the overall empty weight of a conventional ground cargo vehicle of the same class formed to have a metal chassis and a metal body.

13. The ground cargo vehicle according to claim 1, wherein the ground cargo vehicle has an overall empty weight of less than or equal to about 10,000 pounds, and the interior space of the cargo compartment has a volume of at least about 1,000 cubic feet.

14. A ground cargo vehicle comprising:
(i) a chassis formed of a reinforced polymer composite material and having an upward-facing surface defining a floor of the ground cargo vehicle;
(ii) multiple wheels mounted on the chassis such that the chassis is mobile upon the wheels;
(iii) a drive system mounted on the chassis and comprising a plurality of drive components;
(iv) an upper housing attached to the chassis and formed of a reinforced polymer composite material;
(v) a driver bulkhead;
(vi) a rear door;
wherein the floor, the upper housing, the driver bulkhead, and the rear door together define a cargo compartment with an interior space having a defined cargo volume; and
(vii) a cab compartment positioned forward to the cargo compartment and separated therefrom by the driver bulkhead;
wherein the chassis comprises one or more channels for accommodating one or more of the plurality of drive components; and
wherein the floor of the ground cargo vehicle defines the lowest portion of the cargo compartment and the cab compartment and is uniform in height from the cargo compartment to the cab compartment.

15. The ground cargo vehicle according to claim 14, wherein the drive system comprises a 4-cylinder diesel internal combustion engine.

16. The ground cargo vehicle according to claim 14, wherein the drive system comprises a hybrid drive system.

17. The ground cargo vehicle according to claim 15, wherein the hybrid drive system comprises an internal combustion drive component and an electrical drive component.

18. The ground cargo vehicle according to claim 14, wherein the floor is disposed lower than the top of at least one of the wheels.

19. The ground cargo vehicle according to claim 14, wherein the floor has a height of less than 24 inches.

20. The ground cargo vehicle according to claim 14, wherein the floor has a height of less than 14 inches.

21. The ground cargo vehicle according to claim 14, wherein the ground cargo vehicle has an overall empty weight of less than or equal to about eight thousand pounds, and the interior space of the cargo compartment has a volume of at least about one thousand cubic feet.

22. The ground cargo vehicle according to claim 14, wherein the chassis, the upper housing, and the driver bulkhead are an integrated self-supporting monocoque construction molded as one piece and comprised completely of a reinforced polymer composite material.

23. A method for reducing the cost of operation of a ground cargo delivery vehicle, the method comprising:
(A) providing a ground cargo delivery vehicle having:
(i) a chassis formed of a reinforced polymer composite material and having an upward-facing surface defining a floor of the ground cargo vehicle;
(ii) multiple wheels mounted on the chassis such that the chassis is mobile upon the wheels;
(iii) a hybrid drive system mounted on the chassis;
(iv) an upper housing attached to the chassis and comprising a reinforced polymer composite material;
(v) a driver bulkhead; and
(vi) a rear door;
wherein the floor, the upper housing, the driver bulkhead, and the rear door together define a cargo compartment with an interior space having a defined cargo volume;
wherein the ground cargo vehicle has an overall empty weight that is at least about 20% less than the overall empty weight of a conventional ground cargo vehicle of the same class formed to have a metal chassis and a metal body, and the interior space of the cargo compartment has a volume of at least about 1,000 cubic feet; and
(B) using the ground cargo delivery vehicle in a daily operation for ground cargo delivery.

24. The method of claim 23, wherein the chassis, the upper housing, and the driver bulkhead are formed in an integrated self-supporting monocoque construction molded as one piece and comprised completely of a reinforced polymer composite material.

25. The method of claim 23, wherein the vehicle has an overall empty weight of less than or equal to about 10,000 pounds.
